(19) United States
(12) Patent Application Publication
(10) Pub. No.: US 2007/0231452 A1
(43) Pub. Date: Oct. 4, 2007

(54) SPICE FORMS

(76) Inventor: Velissa Myra VAN SCOYOC, Pottstown, PA (US)

Correspondence Address: James R. Williams, 3103 Wilmington Road, New Castel, PA, 16105, US

(21) Appl. No.: 11/691,661

(22) Filed: Mar. 27, 2007

Related U.S. Application Data
(60) Provisional application No. 60/787,084, filed on Mar. 29, 2006.

(51) Int. Cl. A23L 1/221

(52) U.S. Cl. 426/650

(57) ABSTRACT

The present invention describes an article comprising spice, a method of manufacturing the article, and a use of the article in cooking foods. The article includes a solid form comprising at least one spice. The method of producing the article includes pressing a spice powder, packing flaked spice into a bale, or suspending the spice in a suitable matrix. Conveniently, a plurality of spices are combined in the form yet kept separate until use. The spice form may be used in any number of cooking applications. The situation dictates the type of shape to be used. The articles may be used by crumbling, grating, cutting, dissolving, or infusing the article into a recipe. The forms may even be produced in preset dispensing amounts.

The present invention claims priority to U.S. provisional application No. 60/787,084, which is hereby incorporated by reference.

### FIELD OF THE INVENTION

The invention relates to an article and method for storing, displaying, and using spices.

### BACKGROUND OF THE INVENTION

Spices are traditionally stored in containers, whether jars, cans, bags, pouches, etc. Such containers can facilitate storage and may even improve shelf-life of spices. Disadvantageously, containers obscure and may not optimally preserve their contents. Further, similar containers as well as similar appearance of certain spices can cause chiefs to confuse ingredients. Current methods of storing or using spices often lack aesthetic appeal. Additionally, traditional storage methods can inhibit the measuring or dispensing of spices.

A need exists for a better, more efficient, more aesthetically pleasing way of storing, cooking with and using spices. A need also exists to allow cooks to create new cuisines and flavors without professional expertise to create those dishes.

### SUMMARY OF THE INVENTION

The present invention describes an article comprising spice, a method of manufacturing the article, and a use of the article in cooking foods. The article includes a solid form comprising at least one spice. The article may include a second ingredient, such as a binder, filler or preservative. The solid form may be any convenient shape and may also be described by one or more colors, impressions, patterns or writings. The form may correspond to a particular amount of spice, such as, one teaspoon, one gram, etc. Advantageously, a different solid form defines each spice or combination of spices. The solid form can improve shelf-life of the spice by reducing the surface area exposed to air and light.

The method of producing the form includes pressing a spice powder, packing flaked spice into a bale, or suspending the spice in a suitable matrix. A suspension may be formed from a jelled or colloidal material or by mixing the spice with a matrix material above the melting point of the matrix material and allowing the matrix to cool. The method permits combinations of spices to be produced. Suspending the spice in a matrix permits greater control over expensive or particularly pungent spices, such as saffron.

The spice form may be used in any number of cooking applications. The situation dictates the type of shape to be used. The articles may be used by crumbling, grating, cutting, dissolving, or infusing the article into a recipe. Use is facilitated by producing forms of various dispensing amounts.

### BRIEF DESCRIPTION OF THE DRAWINGS

FIG. 1 shows a first embodiment of the invention.

FIG. 2 shows a second embodiment of the invention.

FIG. 3 shows a third embodiment of the invention.

FIG. 4 shows a fourth embodiment of the invention.

FIG. 5 shows a fifth embodiment of the invention.

FIG. 6 shows a sixth embodiment of the invention.

FIG. 7 shows a seventh embodiment of the invention.

FIG. 8 shows an eighth embodiment of the invention.

FIG. 9 shows a ninth embodiment of the invention.

### DETAILED DESCRIPTION OF THE INVENTION

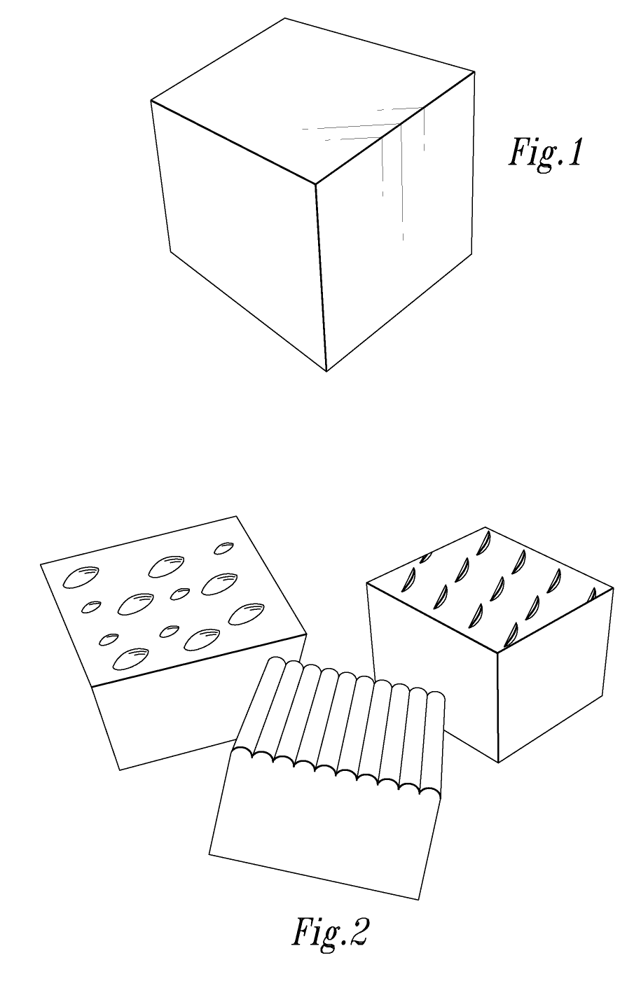

FIG. 1 shows a general embodiment of the article of the invention. The article includes at least one spice shaped into a form. The form may be of any shape, but is conveniently a block. The spice is first refined as needed, then prepared. Preparation includes pressing, drying, freeze drying or dehydrating the spice. The spice may be mixed with one or more other spices, so that the article includes spices used in making distinct cultural dishes.

In addition to the spice, the form may include additives, such as colorants, binders and preservatives. Additives may enhance aesthetic appeal, shelf-life, usability, etc. For example, cinnamon has been pressed with a binder such as agar gum, to produce a cube of cinnamon. Alternative binders include gelatin, starch, calcium stearate, glycerine, magnesium state, monoglycerides, diglycerides, gelatins, colloids, and their combinations. The forms are unencumbered by packaging. A cook's recognition of the spice improves by eliminating extraneous packaging and focusing attention on the spice itself. The present invention uses the spice as the packaging and expensive or cumbersome containers are eliminated.

Color, texture, and taste considerations may be designed into the forms, each with its own “personality.” Examples include whipped onion butter, lemon pepper, orange peel, raw parsley, honey mustard, and chili explosions, each with its own characteristics and processing. In various embodiments, a plurality of spices may be present in a form but kept separated until use. Such formed spices can retain their individual flavors for longer periods of time. In contrast, prior art typically mixes powdered or granulated spices into a single container. Over time, the individual flavors of the powdered or ground spices can mingle. The exposed surface area of the spices likely contributes to the degeneration and commingling of flavors.

Conveniently, the shape conforms to a standard unit of measure, which a cook can add to a dish as needed. Standard units of measurement include teaspoon, tablespoon, ounce, milliliter, gram, etc. The spice form may include binder or inert filler so that the form is of a convenient size despite the quantity of spice actually required. For example, saffron is expensive and most dishes require a small amount. A measure of saffron may be combined with a binder or filler to produce a spice form of a convenient size. The form may be used whenever the measure of saffron is required. The spice form includes a predetermined amount of saffron so that adding to much or too little of the costly ingredient is avoided.

Spice shapes may be assembled to produce an aesthetically pleasing configuration. Food colorants may be added to the shapes in order to distinguish the shapes and spices from each other. For example, red food colorant may be added at increasingly levels to identify increasingly spicy forms comprising chili pepper.

Formed blocks of spices and flavors are also valuable for their preservation properties. Compressing spices into a solid form protects the flavor of the spice from deteriorating over time. Loose granulated spices include large surface areas that may oxidize, or absorb moisture and other flavors. Unlike loose spice, the flavors in a spice form are released just prior to cooking by grating or breaking off pieces as needed. The concept is to provide a more consistent flavor over the lifespan of the spice. As with most food, freshness is the key to better tasting food, and compressing spices into blocks is a viable way of maintaining that freshness. It is also possible, while not necessary in all cases, to include natural preservations in the slurry mix of spices while producing the blocks. These preservations can be tasteless but provide another level of flavor protection.

By packaging flavors together in combinations, with new textures, ethnic mixes, blends, and densities, the present invention offers people not just an easier way to prepare food, but engaging the user while at the market and while preparing the food.

The present invention also permits spices to be displayed at a store, restaurant or home and offers to cooks the ability to create their favorite dishes easily. By offering stimulating, flavorful combinations of spices, a higher value for the ingredients are achieved.

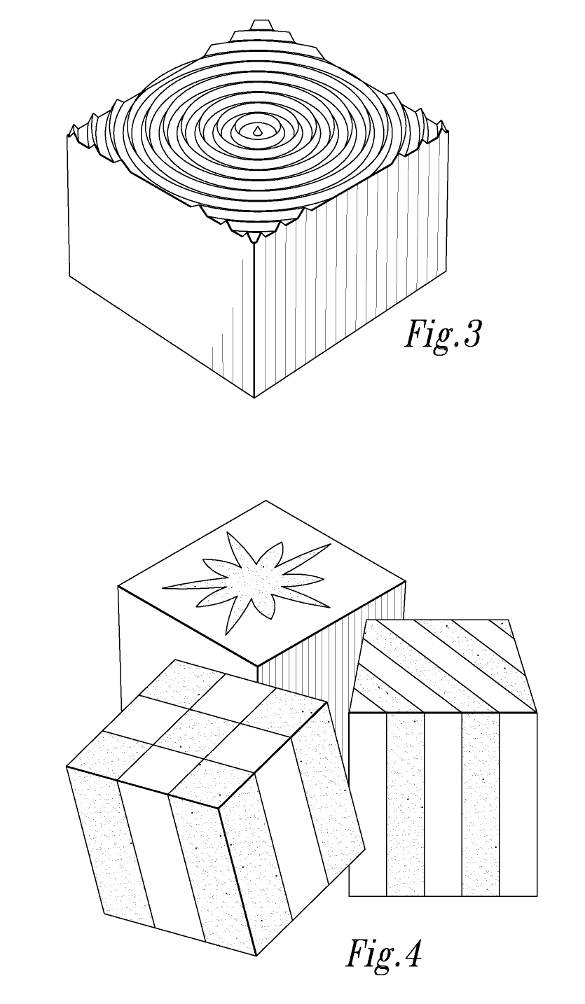

FIG. 2 shows several spice forms shaped by pressing at least one spice. The spice may include a binder. The forms include a patterned surface such as, for example, scallops, waves and bevels. The pattern may raised or indented, and may include any pattern that can be pressed into or onto a surface, including letters or numbers. The pressed form may be grated, cut, smashed, torn or otherwise added as a flavoring in cooking. Finer textures of the spice permit more detailed patterns. FIG. 8 shows a finely ground, compressed spice form with more complex patterns. Typically, finely ground spices can be more easily formed and broken apart during use.

FIG. 3 shows a “whipped” form comprising at least one spice in a base. Examples include onion in buttermilk or garlic mousse. A measure of spice may be added to the base. The base may comprise butter or cream. The spice is mixed with the base by any convenient means. Air may be incorporated into the mixture. The mixture may be extruded, pressed or otherwise formed into a shape.

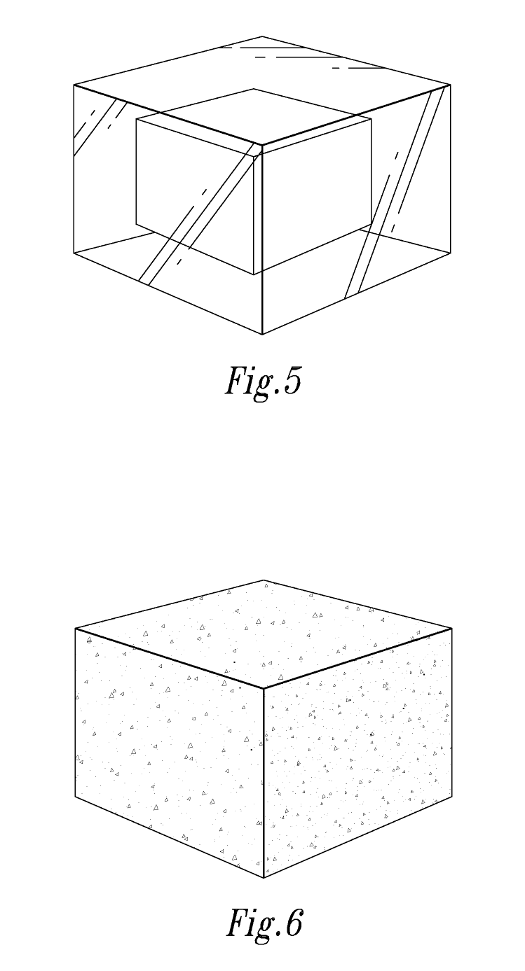

FIG. 4 shows a spice form comprising at least two spices. The separate spices may be blended to produce a textured shape. The spices may be separated into sections to produce various patterns, such as stripes or checks. Separated spices are aesthetically effective when the spices' colors are complementary.

FIG. 5 shows a “jelly,” which includes at least one spice infused in a gelatin or colloidal matrix. One skilled in the art would be aware of a number of products capable of forming a jelly matrix. A jelly may include an infused oil to facilitate dispersal of the spice into the food. The jelly may dissolve in oil or boiling water, thereby providing an “explosion” of flavor. Conveniently during storage, oil may be suspended in the jelly apart from the spice. In this manner, the flavor of the spice is not dissipated during storage by commingling with the oil.

FIG. 6 shows a bale of dried spices that have not been ground and are still in flake form. Bales may comprise raw and minimally processed spices, and may contain small branches of spice or separated leaves or petals. The bale is compressed into a block similar to a regular agricultural haybale but on a smaller scale. The objective is to retain the original texture of the dried spice but in a more manageable form.

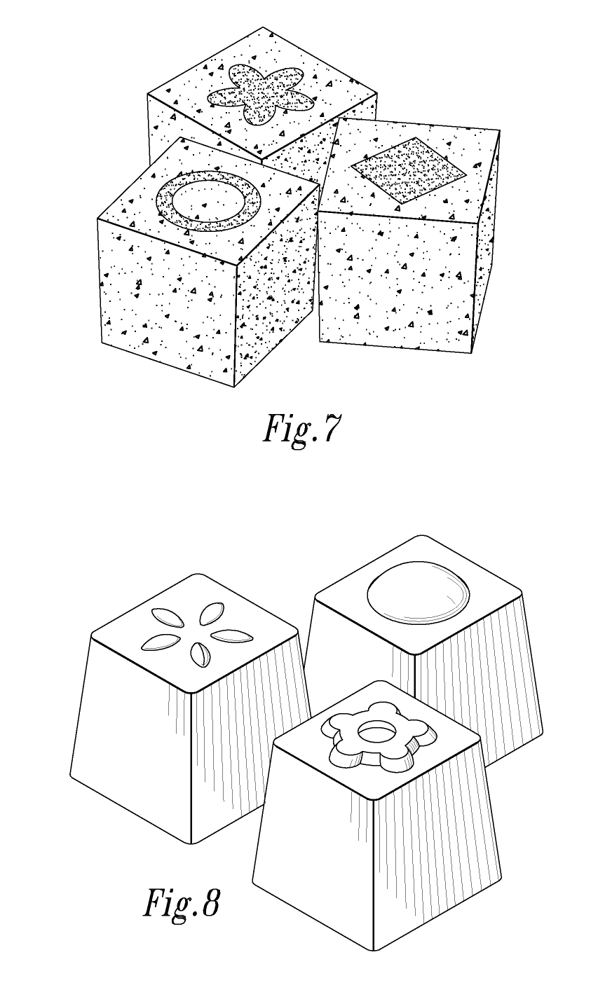

FIG. 7 shows “cookie cutter” cakes. The cakes are extruded solids, and include at least one spice. The solid may also include fruit or other non-spice ingredient. The ingredients are shaped into a form but their flavors are not combined until the cake is grated or crushed into a recipe. Examples include lemon pepper, raspberry cinnamon, and vanilla coconut. The co-extruded solids may be stored and used together but without deterioration of the uniqueness of each spice.

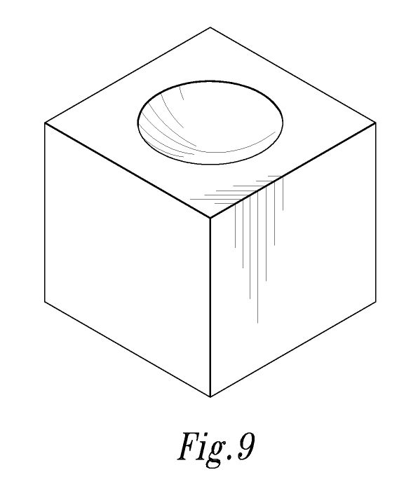

FIG. 9 shows a form comprising a solidified colloid with at least one spice. Typically, the colloid comprises milk and the milk solids comprise a large percentage of the form. This article is particularly useful with expensive spices such as saffron because less spice is present in the form. The spice may be dispersed uniformly through the shape or collected at one or more areas of the shape. The areas may be on a surface of the form and may include an indent.

Obviously, numerous modifications and variations of the present invention are possible. It is, therefore, to be understood that within the scope of the following claims, the invention may be practiced otherwise than as specifically described. While this invention has been described with respect to certain preferred embodiments, different variations, modifications, and additions to the invention will become evident to persons of ordinary skill in the art. All such modifications, variations, and additions are intended to be encompassed within the scope of this patent, which is limited only by the claims appended hereto.

What is claimed:

1. An article comprising at least one spice shaped into a solid form.

2. The article of claim 1, wherein the article includes an ingredient selected from a group consisting of binders, fillers, preservatives and combinations thereof.

3. The article of claim 2, wherein the binder is selected from a group consisting of gelatin, starch, agar gum, calcium stearate, glycerine, magnesium state, monoglycerides, diglycerides, and combinations thereof.

4. The article of claim 1, wherein the filler is selected from a group consisting of colorants, oils, milk solids, fruits, vegetables, and combinations thereof.

5. The article of claim 1, wherein the solid form includes an exterior surface having a pattern.

6. The article of claim 1, wherein the solid form includes a plurality of spices.

7. The article of claim 5, wherein the spices are distributed substantially homogeneously throughout the solid form.

8. The article of claim 5, wherein the spices are distributed substantially heterogeneously throughout the solid form.

9. The article of claim 1, wherein the solid form includes at least two sections comprising different spices.

10. The article of claim 1, wherein the solid form defines a standard unit of measure for the spice.

11. A method of shaping a spice into a solid form comprising preparing the spice and shaping the spice into the solid form.

12. The method of claim 10, wherein preparing comprises an action selected from a group consisting of grinding, granulating, mixing, blending, pureeing, and combinations thereof.

13. The method of claim 10, wherein shaping is selected form a group consisting of pressing, extruding, bailing, gelling, and solidifying.

14. The method of claim 10, wherein the method includes drying the solid form.

15. A solid form for use in cooking comprising at least one spice and an additive.

16. The solid form of claim 16, wherein the additive is selected from a group consisting of a binder, a filler and combinations thereof.

17. The solid form of claim 16, wherein the form includes a premeasured amount of the spice.

18. The solid form of claim 18, wherein the premeasured amount is a standard unit of measure.
